(19) United States
(12) Patent Application Publication
(10) Pub. No.: US 2025/0254293 A1
(43) Pub. Date: Aug. 7, 2025

(54) POSITION DEPENDENT PREDICTION COMBINATION FOR VIDEO CODING

(71) Applicant: Samsung Electronics Co., Ltd., Suwon-si (KR)

(72) Inventors: Saifeng Ni, Santa Clara, CA (US); Madhukar Budagavi, Plano, TX (US); Rajan Laxman Joshi, San Diego, CA (US)

(21) Appl. No.: 18/924,934

(22) Filed: Oct. 23, 2024

Related U.S. Application Data
(60) Provisional application No. 63/550,912, filed on Feb. 7, 2024.

(51) Int. Cl. H04N 19/11; H04N 19/593

(52) U.S. Cl. CPC H04N 19/11; H04N 19/593

(57) ABSTRACT

An apparatus directed to improvements of position-dependent intra prediction sample filtering process in video coding is provided. The apparatus receives a compressed bitstream and performs an intra prediction process based on an intra prediction mode for a current block to generate an intra predicted sample for a current sample in the current block. The apparatus determines a weight array based on the intra prediction mode for the current block, from a plurality of weight arrays, each of the plurality of weight arrays being associated with a respective one of a plurality of intra prediction modes, determines a weight from the determined weight array based on a position of the current sample, and generate a modified intra predicted sample for the current sample based on the determined weight and the intra predicted sample for the current sample.

### CROSS REFERENCE TO RELATED APPLICATION

This application claims benefit of U.S. Provisional Application No. 63/550,912 filed on Feb. 7, 2024, in the United States Patent and Trademark Office, the entire contents of which are hereby incorporated by reference.

### TECHNICAL FIELD

The disclosure relates to video coding, and more particularly to, for example, but not limited to, position dependent prediction combination for video coding.

### BACKGROUND

Intra prediction exploits spatial correlation within a picture or within a picture region. In order to improve coding efficiency, the High-Efficiency Video Coding (HEVC) standard and Versatile Video Coding (VVC) standard exploit block-based spatial prediction extensively. In VVC, multiple Intra prediction modes are used to exploit spatial features. The size of the prediction unit (PU) for Intra coding may be 1×16, 1×32, 2×8, 2×16, 2×32, 4×4, 4×8, 4×16, 4×32, 8×8, 8×16, 8×32, 16×16, 16×32, 16×64, 32×32, 64×64. The number of Intra angular modes increased to 65 with block shape-adaptive directions.

In the intra prediction in video coding standards such as Advanced Video Coding (AVC) and HEVC, the samples in the current block are predicted from already reconstructed left and top neighboring samples of the current block, referred to as reference samples. VVC has angular intra prediction as well. In comparison to HEVC, VVC increased the prediction accuracy by enlarging the number of angular prediction directions and also by more accurate interpolation filters. While the HEVC standard uses 33 directional modes, the VVC standard uses 65 directional modes. Besides that, VVC also adopted new partitioning framework by introducing wide-angular intra prediction modes which can deal with blocks with rectangular shape, where more prediction directions are assigned to the longer side of a block. The additional modes on the longer side are called Wide-Angle Intra Prediction (WAIP) mode.

Similar to HEVC, intra prediction in VVC has two filtering mechanisms applied on reference samples: reference sample smoothing and interpolation filtering. Reference sample smoothing is applied only to integer-slope mode for luma blocks while interpolation filtering is applied on fractional-slope mode. 4-tap interpolation filters including a DCT-based interpolation filter (DCTIF) and a 4-tap smoothing interpolation filter (SIF) are used for luma blocks.

The Matrix-based Intra Prediction (MIP) mode is a new concept of intra prediction proposed in VVC, which is a data-driven method. There are 3 main steps for MIP in VVC standard. The first step is reference sample down sampling, where the top and left reference samples are reduced to a smaller size. The reference boundary is reduced to 2 for 4×4 blocks and to 4 for all the other blocks. In current VVC standard, the averaging of reference samples is used for the down sampling process. After that, two reduced boundary samples are concatenated and transformed based on mipTranspose. The second step is to do matrix vector multiplication based on the mipSizeId and mode k. The number of MIP modes is equal to 16 for mipSizeId=0, equal to 8 for mipSizeId=1 and equal to 6 for mipSizeId=2. With the additional indicator mipTranspose, the actual number of modes for each mipSizeId is doubled. The mode k of a MIP block is searched in encoder and signaled in decoder. After the matrix and vector multiplication, a reduced prediction is generated. The reduced prediction size is 4×4 for mipSizeId=0 and 1 and 8×8 for mipSizeId=2. The last step is to do two rounds of linear interpolation, first a horizontal and then a vertical, to up sample the reduced prediction to a full prediction.

The position-dependent prediction combination (PDPC) has been introduced in the VVC standard. The PDPC is a filtering technique applied to the intra prediction of Planar, DC, horizontal, vertical intra models and also certain angular modes. The filter has position-dependent weights to adjust the prediction. The spatial varying weights are used in the filtering process and corresponding reference samples are involved to correct the pixels in the prediction blocks. Three different PDPC schemes are designed in VVC for those 4 different intra prediction modes, where Planar and DC use the same scheme. The main difference of PDPC schemes for different prediction modes are how to get the reference samples for each pixel in the prediction block and whether to correct the prediction without top reference or without left reference. However, the same position weight coefficients are used in the PDPC calculation for all different modes and for all the blocks. It is disabled if the block width or height is smaller than 4 samples, or if the MRL mode is used, or if BDPCM is used.

Different positional weighting schemes and reference sample mapping schemes are used depending on the intra prediction mode in VVC. However, when non-zero weights are applied on either the top reference or the left reference, the same non-zero positional weights have been adopted for the top reference samples or the left reference samples regardless of the intra prediction modes. In particular, PDPC weights w_{L} and w_{T} are determined by using Equation 1 in VVC.

$${w}_{L} = 32 ≫ ( ( x ≪ 1 ) ≫ scale ) \qquad Equation 1$$

$${w}_{T} = 32 ≫ ( ( y ≪ 1 ) ≫ scale )$$

As shown in Equation 1, in VVC, the same set of weights is used for the same scale regardless of the intra prediction mode. For example, when the scale is 0, a set of weights 32, 8, 2, 0 is used for all intra prediction modes in PDPC of VVC.

Furthermore, as shown in Equation 1, in VVC, a set of weights for a smaller scale is always a subset of a set of weights for a bigger scale. For example, the set of weights for a scale of 0 is a subset of the set of weights for a scale of 1, because weights for a scale of 0 are 32, 8, 2, 0 and weights for a scale of 1 are 32, 16, 8, 4, 2, 1, 0, 0. The set of weights for a scale of 1 is a subset of the set of weights for a scale of 2, because weights for a scale of 1 are 32, 16, 8, 4, 2, 1, 0, 0 and weights for a scale of 2 are 32, 32, 16, 16, 8, 8, 4, 4, 2, 2, 1, 1, 0, 0, 0, and 0.

However, since different features of a block lead to different prediction modes, using the same positional weights regardless of the intra prediction mode may result in a low video compression efficiency.

The description set forth in the background section should not be assumed to be prior art merely because it is set forth in the background section. The background section may describe aspects or embodiments of the present disclosure.

### SUMMARY

The present disclosure is directed to improvements of video coding. In particular, the present disclosure is directed to improvements of position-dependent intra prediction sample filtering process in video coding.

In some embodiments, better positional weights for PDPC depending on the intra prediction mode including Planar, DC, Horizontal/Vertical and certain Angular mode may be introduced. Different position weight schemes for PDPC will be also proposed. In the present disclosure, the weighting schemes for different prediction modes are optimized. Furthermore, position weight schemes depending on the block size will be suggested. Different position weighting schemes based on block features and prediction modes will be explored in the present disclosure.

In some embodiments, an apparatus comprises a communication interface configured to receive a compressed bitstream; and a processor operably coupled to the communication interface, the processor configured to: perform an intra prediction process based on an intra prediction mode for a current block to generate an intra predicted sample for a current sample in the current block, determine a weight array based on the intra prediction mode for the current block, from a plurality of weight arrays, each of the plurality of weight arrays being associated with a respective one of a plurality of intra prediction modes, determine a weight from the determined weight array based on a position of the current sample, generate a modified intra predicted sample for the current sample based on the determined weight and the intra predicted sample for the current sample.

In some embodiments, the plurality of weight arrays include a first weight array and a second weight array, the first weight array is associated with a first intra prediction mode, the second weight array is associated with a second intra prediction mode, and the first weight array is different from the second weight array.

In some embodiments, the first intra prediction mode is one of a Planar mode, a DC mode, a horizontal mode, a vertical mode, or an angular mode, and the second intra prediction mode is another one of the Planar mode, the DC mode, the horizontal mode, the vertical mode, or the angular mode.

In some embodiments, the weight array is determined further based on a scale, the scale is determined based on a size of the current block, and each of the plurality of weight arrays is associated with a respective one of the plurality of intra prediction modes and associated with a respective one of a plurality of scales.

In some embodiments, the plurality of weight arrays include a first weight array and a second weight array, the first weight array is associated with a first intra prediction mode and a first scale, the second weight array is associated with a second intra prediction mode and the first scale, and the first weight array is different from the second weight array.

In some embodiments, the plurality of weight arrays include a first weight array and a second weight array, the first weight array is associated with a first intra prediction mode and a first scale, the second weight array is associated with a first intra prediction mode and a second scale, and the first weight array is different from the second weight array.

In some embodiments, the second scale is bigger than the first scale, and a set of elements in the first weight array is not a subset of a set of elements in the second weight array.

In some embodiments, the weight array is determined further based on a width and a height of the current block, each of the plurality of weight arrays is associated with a respective one of the plurality of intra prediction modes, associated with a respective one of a plurality of block widths, and associated with a respective one of a plurality of block heights.

In some embodiments, the plurality of weight arrays include a first weight array and a second weight array, the first weight array is associated with a first intra prediction mode, a first width, and a first height, the second weight array is associated with a second intra prediction mode and the first scale, a first width, and a first height, and the first weight array is different from the second weight array.

In some embodiments, the weight is determined from the determined weight array based on the position of the current sample and a scaling factor, and the scaling factor is greater than 1.

In some embodiments, generating the modified intra predicted sample for the current sample comprises: determining a reference sample based on the position of the current sample, applying the weight to the reference sample to generate a weighted reference sample, and combining the intra predicted sample for the current sample with the weighted reference sample to generate a modified intra predicted sample for the current sample.

In some embodiments, the processor is further configured to cause: determining a residual for the current sample, and combining the residual for the current sample with the residual for the current sample to reconstruct the current sample.

In some embodiments, a video decoding method comprises: receiving a compressed bitstream; performing an intra prediction process based on an intra prediction mode for a current block to generate an intra predicted sample for a current sample in the current block; determining a weight array based on the intra prediction mode for the current block, from a plurality of weight arrays, each of the plurality of weight arrays being associated with a respective one of a plurality of intra prediction modes; determining a weight from the determined weight array based on a position of the current sample; and generating a modified intra predicted sample for the current sample based on the determined weight and the intra predicted sample for the current sample.

In some embodiments, the plurality of weight arrays include a first weight array and a second weight array, the first weight array is associated with a first intra prediction mode, the second weight array is associated with a second intra prediction mode, and the first weight array is different from the second weight array.

In some embodiments, the weight array is determined further based on a scale, the scale is determined based on a size of the current block, and each of the plurality of weight arrays is associated with a respective one of the plurality of intra prediction modes and associated with a respective one of a plurality of scales.

In some embodiments, the plurality of weight arrays include a first weight array and a second weight array, the first weight array is associated with a first intra prediction mode and a first scale, the second weight array is associated with a second intra prediction mode and the first scale, and the first weight array is different from the second weight array.

In some embodiments, generating the modified intra predicted sample for the current sample comprises: determining a reference sample based on the position of the current sample, applying the weight to the reference sample to generate a weighted reference sample, and combining the intra predicted sample for the current sample with the weighted reference sample to generate a modified intra predicted sample for the current sample.

In some embodiments, an apparatus comprises: a processor configured to cause: performing an intra prediction process based on an intra prediction mode for a current block to generate an intra predicted sample for a current sample in the current block, determining a weight array based on the intra prediction mode for the current block, from a plurality of weight arrays, each of the plurality of weight arrays being associated with a respective one of a plurality of intra prediction modes, determining a weight from the determined weight array based on a position of the current sample, generating a modified intra predicted sample for the current sample based on the determined weight and the intra predicted sample for the current sample, and generating a residual for the current sample based on the modified intra predicted sample; and a communication interface operably coupled to the processor, the communication interface configured to transmit the compressed bitstream including a syntax element representing the residual.

In some embodiments, the plurality of weight arrays include a first weight array and a second weight array, the first weight array is associated with a first intra prediction mode, the second weight array is associated with a second intra prediction mode, and the first weight array is different from the second weight array.

In some embodiments, the weight array is determined further based on a scale, the scale is determined based on a size of the current block, and each of the plurality of weight arrays is associated with a respective one of the plurality of intra prediction modes and associated with a respective one of a plurality of scales.

The proposed PDPC weighting schemes can lead to 0.08% (Y) coding gain in all intra prediction modes compared to VTM software. The adaptive PDPC weighting scheme can improve the coding gain to 0.11% (Y) in all intra prediction modes compared to VTM software.

### BRIEF DESCRIPTION OF THE DRAWINGS

FIG. 1 illustrates an example communication system 100 in accordance with an embodiment of this disclosure.

FIGS. 2 and 3 illustrate example electronic devices in accordance with an embodiment of this disclosure.

FIG. 4 illustrates a block diagram for a video encoder in accordance with an embodiment.

FIG. 5 illustrates a block diagram for a video decoder in accordance with an embodiment.

FIG. 6 is a block diagram for an intra-frame predictor in accordance with an embodiment.

FIG. 7 is a flow chart showing a PDPC scheme in accordance with an embodiment.

FIG. 8 is a flow chart showing a PDPC scheme in accordance with an embodiment.

FIG. 9 is a flow chart showing the operation of the intra-frame predictor in accordance with an embodiment.

FIG. 10 shows an x-intercept and a y-intercept of a sample.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

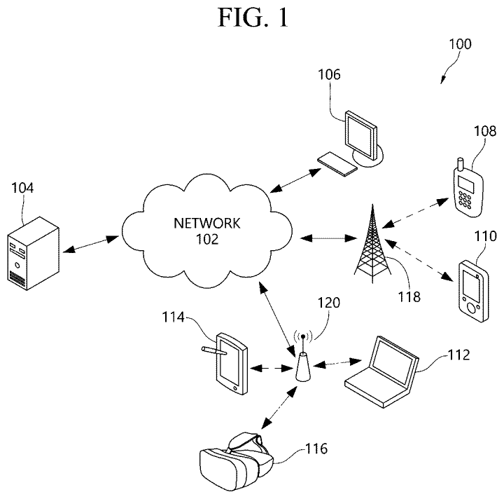

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can then compress 3D point cloud or mesh to generate a bitstream and then transmit the bitstream to one or more of the client devices 106-116. For another example, one of the client devices 106-116 can compress a 3D point cloud or mesh to generate a bitstream and then transmit the bitstream to another one of the client devices 106-116 or to the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

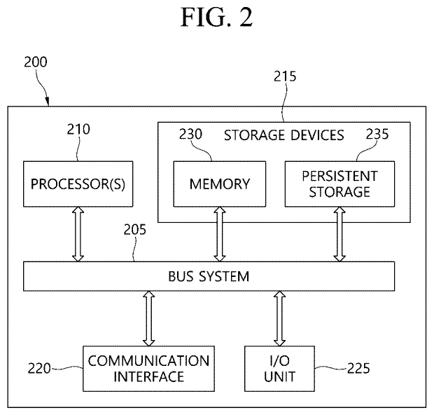

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

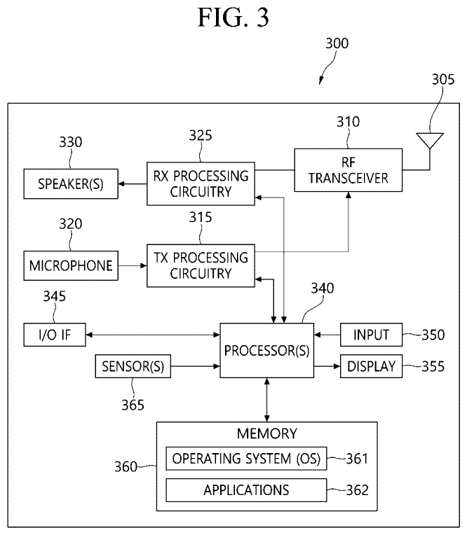

FIG. 4 illustrates a block diagram for a video encoder in accordance with an embodiment.

The video encoder 400 comprises a prediction unit 410, a residual sample generator 420, a transformation processor 430, a quantizer 440, an entropy encoder 450, an inverse quantizer 460, an inverse transformation processor 470, a picture reconstructor 480, and a filter 490.

The prediction unit 410 generates prediction samples for the current block. In some embodiments, as shown in FIG. 4, the prediction unit 410 may comprise an inter-frame predictor 411, an intra-frame predictor 413, and a switch 415.

The inter-frame predictor 411 performs inter prediction process based on a current picture and one or more reference pictures to generate inter-predicted samples for a current block. The inter-frame predictor may generate a reference picture index indicating a reference picture including the inter-predicted samples and a motion vector indicating the inter-predicted samples in the reference picture indicated by the reference picture index.

The intra-frame predictor 413 performs intra prediction process based on the current picture and reconstructed samples of previously encoded samples of the current picture to generate intra-predicted samples for the current block.

The switch 415 selects prediction samples for the current block between the inter-predicted samples and the intra-predicted samples. In some embodiments, the switch 415 may determine a prediction mode between an intra prediction mode and an inter prediction mode and select prediction samples based on the prediction mode.

The residual sample generator 420 subtracts the prediction samples selected by the switch 415 from original samples for a current block to generate residual samples for the current block.

The transformation processor 430 transforms residual samples for the current block to generate transform coefficients for the current block.

The quantizer 440 quantizes transform coefficients for the current block to generate quantized transform coefficients for the current block.

The entropy encoder 450 performs entropy encoding with the quantized transform coefficients for the current block to generate a bitstream.

The inverse quantizer 460 dequantizes quantized transform coefficients for the current block to generate dequantized transform coefficients for the current block.

The inverse transformation processor 470 transforms dequantized transform coefficients for the current block to generate inversely transformed residual samples for the current block.

The picture reconstructor 480 combines the inversely transformed residual samples for the current block with the prediction samples selected by the switch 415 to generate reconstructed samples for the current picture including the current block.

The filter 490 performs one or more filtering operations on the reconstructed samples to generate modified reconstructed samples for the current picture. The reconstructed samples for the current picture are used as a reference picture for inter-frame prediction of the subsequent pictures.

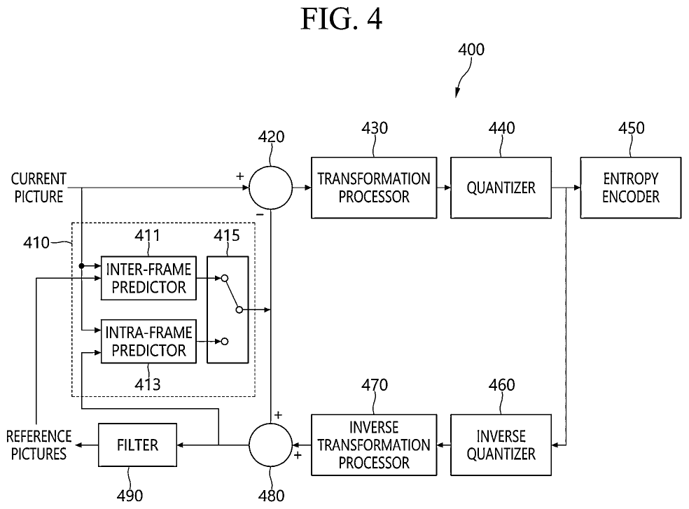

FIG. 5 illustrates a block diagram for a video decoder in accordance with an embodiment.

The video decoder 500 comprises a parser 501, an entropy decoder 503, an inverse quantizer 505, an inverse transformation processor 510, a prediction unit 520, a picture reconstructor 530, and a filter 540.

The parser 501 parses a bitstream to generate one or more syntax elements for transform coefficients for a current block.

The entropy decoder 503 entropy-decodes the one or more syntax elements for transform coefficients to generate transform coefficients for the current block.

The inverse quantizer 505 dequantizes transform coefficients for the current block based on a quantization parameter to generate dequantized transform coefficients for the current block.

The inverse transformation processor 510 transforms dequantized transform coefficients for the current block to generate residual samples for the current block.

The prediction unit 520 generates prediction samples for the current block. In some embodiments, as shown in FIG. 5, the prediction unit 520 comprises an inter-frame predictor 521, an intra-frame predictor 523, and a switch 525.

The inter-frame predictor 521 generates inter-predicted samples for the current block based on one or more reference pictures indicated by one or more reference picture indices signaled in the bitstream and based on one or more motion vectors signaled in the bitstream.

The intra-frame predictor 523 generates intra-predicted samples for the current block based on reconstructed samples of previously decoded samples of the current picture and based on an intra prediction mode.

The switch 525 selects prediction samples for the current block between the inter-predicted samples and the intra-predicted samples. In some embodiments, the switch 525 may determine a prediction mode between an intra prediction mode and an inter prediction mode and select prediction samples based on the prediction mode. In some embodiments, the switch 525 may select an intra-predicted samples as the prediction samples when the prediction mode indicates an intra prediction and select an inter-predicted samples as the prediction samples when the prediction mode indicates an inter prediction.

The picture reconstructor 530 combines the residual samples with the prediction samples to generate reconstructed samples for the current picture including the current block.

The filter 540 applies at least one of a plurality of filters to reconstructed samples for the current picture to generate modified reconstructed samples for the current picture. The reconstructed samples for the current picture are used as a reference picture for inter-frame prediction of the subsequent pictures.

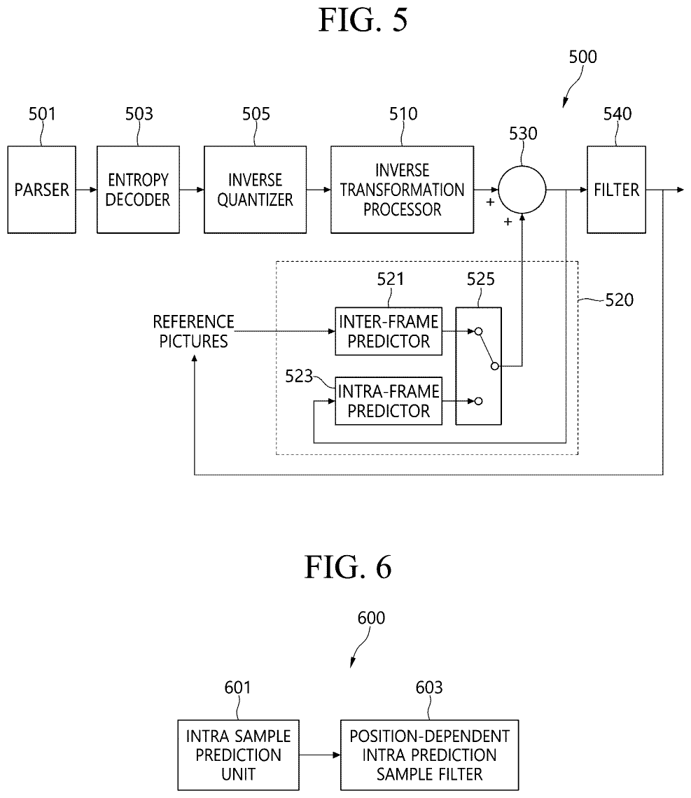

FIG. 6 is a block diagram for an intra-frame predictor in accordance with an embodiment.

The intra-frame predictor 600 shown in FIG. 6 may correspond to the intra-frame predictor 413 shown in FIG. 4 or the intra-frame predictor 523 shown in FIG. 5.

Referring to FIG. 6, the intra-frame predictor 600 in accordance with an embodiment comprises an intra sample prediction unit 601 and a position-dependent intra prediction sample filter 603.

The intra sample prediction unit 601 performs an intra prediction process based on already decoded neighboring reference samples for the current block and an intra prediction mode to generate intra prediction samples for the current block.

The position-dependent intra prediction sample filter 603 performs PDPC with intra prediction samples for the current block based on the intra prediction mode to generate modified intra prediction samples for the current block.

Hereinafter, position-dependent intra prediction sample filtering process in VVC will be described.

If PDPC is applied, the prediction at (x, y) is calculated as shown in Equation 2.

$$P ( x , y ) = ( {w}_{L} {R}_{L} + {W}_{T} {R}_{T} + ( 64 - {w}_{L} - {w}_{T} ) P ( x , y ) + 32 ) ≫ 6 \qquad Equation 2$$

In Equation 2, w_{L} and w_{T} are positional dependent weights, R_{L} and R_{T} are neighboring reference samples at the left and top of the current block.

The reference samples R_{L} and R_{T} and position dependent weights w_{L} and w_{T} for Planar and DC modes in VVC are as shown in Equation 3.

$${R}_{L} = R ( - 1 , y ) \qquad Equation 3$$

$${R}_{T} = R ( x , - 1 )$$

$${w}_{L} = 32 ≫ ( ( x ≪ 1 ) ≫ scale )$$

$${w}_{T} = 32 ≫ ( ( y ≪ 1 ) ≫ scale )$$

$$scale = ( {log}_{2} w + {log}_{2} h - 2 ) ≫ 2 ,$$

where w and h are the width and height of the block, R is the reference sample, (x, y) are the pixel coordinates inside the block.

In Equation 3, x>>y represents arithmetic right shift of a two's complement integer representation of x by y binary digits. x<<y represents arithmetic left shift of a two's complement integer representation of x by y binary digits.

The reference samples R_{L} and R_{T} and position dependent weights w_{L} and w_{T} for horizontal and vertical intra modes in VVC are determined as shown in Equation 4.

$${R}_{L} = R ( - 1 , y ) - R ( - 1 , - 1 ) + P ( x , y ) \qquad Equation 4$$

$${R}_{T} = R ( x , - 1 ) - R ( - 1 , - 1 ) + P ( x , y )$$

$${w}_{L} = \{ \begin{matrix}32 ≫ ( ( x ≪ 1 ) ≫ scale ) & if Vertical Intra Modes \\ 0 & else\end{matrix}$$

$${w}_{T} = \{ \begin{matrix}32 ≫ ( ( x ≪ 1 ) ≫ scale ) & if Horizontal Intra Modes \\ 0 & else\end{matrix}$$

$$scale = ( {log}_{2} w + {log}_{2} h - 2 ) ≫ 2$$

The reference samples R_{L} and R_{T} and position dependent weights w_{L} and w_{T} for angular intra modes greater than or equal to 51 in VVC are determined as shown in Equation 5.

$$yIntercept = y + ( ( ( x + 1 ) \times invAng + 256 ) ≫ 9 ) \qquad Equation 5$$

$$scale = min ( 2 , {log}_{2} h - floor ( {log}_{2} ( 3 \times invAng - 2 ) ) + 8 )$$

$${R}_{L} = \{ \begin{matrix}R ( - 1 , yIntercept ) & if x < ( 3 ≪ scale ) \\ 0 & else\end{matrix}$$

$${R}_{T} = 0$$

$${w}_{L} = 32 ≫ ( ( x ≪ 1 ) ≫ scale )$$

$${W}_{T} = 0$$

In Equation 5, min(x, y) returns the smallest number between x and y, and floor(x) returns the largest integer less than or equal to x.

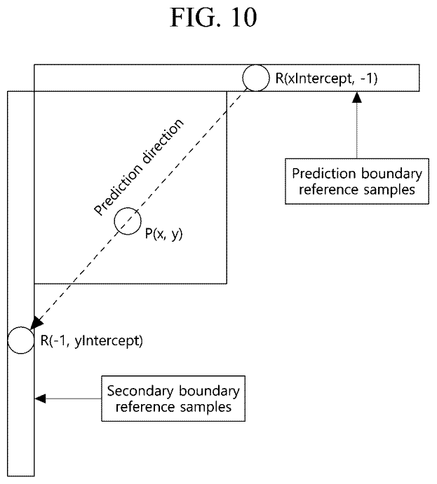

If angle mode is less than or equal to 17, the x-intercept with the reference boundary is calculated based on the prediction direction as shown in FIG. 10. The reference samples and weights are computed similarly to Equation 5.

FIG. 10 shows an x-intercept and a y-intercept of a sample.

As shown in FIG. 10, the variable xIntercept indicating an x-intercept for PDPC of a current sample P(x, y) in a current block may represent a horizontal sample position of a top boundary reference sample R(xIntercept,−1) where a line which crosses the current sample P(x, y) and whose slope is the prediction direction of the current sample intersects a top boundary line formed by top boundary reference samples of the current block. The variable yIntercept indicating an y-intercept for PDPC of the current sample P(x, y) in a current block may represent a vertical sample position of a left reference sample R(−1, yIntercept) where a line which crosses the current sample Px, y) and whose slope is the prediction direction of the current sample intersects a left boundary line formed by left boundary reference samples of the current block.

Different positional weighting schemes and reference sample mapping schemes are used depending on the intra prediction mode in VVC. However, when non-zero weights are applied on either the top reference or the left reference, the same non-zero positional weights have been adopted for the top reference samples or the left reference samples regardless of the intra prediction modes. Suppose a weight vector wₜ with the length of 16 may be represented as follows: wₜ=[32,32,16,16,8,8,4,4,2,2,1,1,0,0,0,0].

Since the max block size is 64×64, the max scale value is 2, and the minimal scale value is 0, the possible weights used in VVC for three scales may be summarized as shown in Table. Table 1 shows PDPC weights for scales 0, 1, and 2 in VVC.

TABLE 1

| scale | weights |
|---|---|
| 0 | wₜ[z << 2], i.e. [32, 8, 2, 0] |
| 1 | wₜ[z << 1], i.e. [32, 16, 8, 4, 2, 1, 0, 0] |
| 2 | wₜ[z], i.e. [32, 32, 16, 16, 8, 8, 4, 4, 2, 2, 1, 1, 0, 0, 0, 0] |

In Table 1, the variable z represents either one of the pixel coordinates x or y, i.e., z=x∈{0, 1, . . . w} or z=y∈{0, 1, . . . , h}.

As shown in Table 1, in VVC, the same set of weights is used for the same scale regardless of the intra prediction mode. Furthermore, as shown in Table 1, in VVC, a set of weights for a smaller scale is always a subset of a set of weights for a bigger scale.

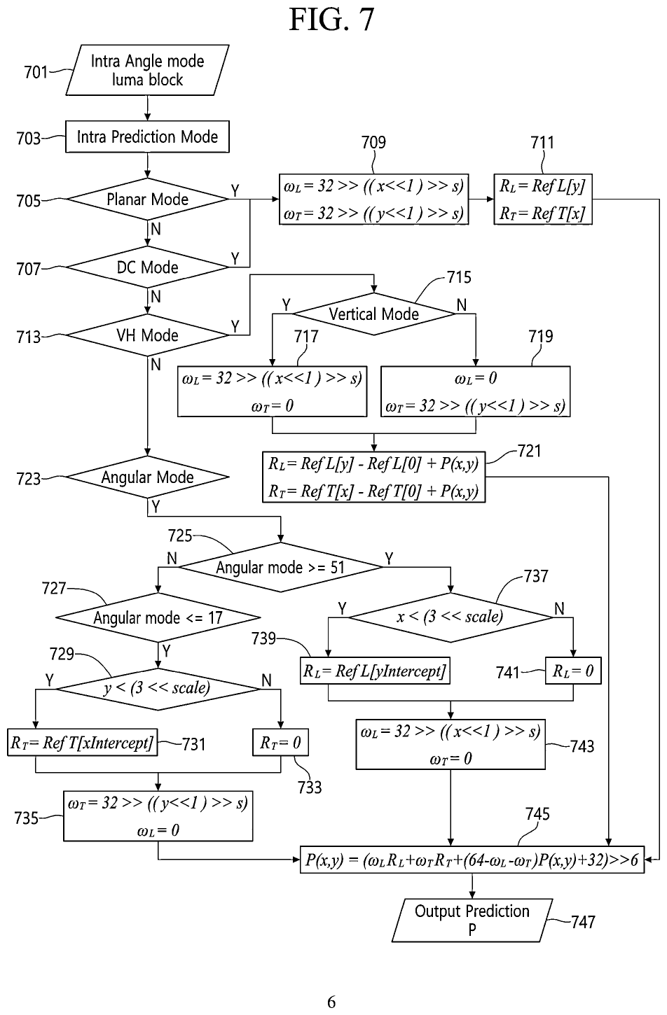

Hereinafter, position-dependent intra prediction sample filtering process will be described with reference to FIG. 7.

FIG. 7 is a flow chart showing a PDPC scheme in accordance with an embodiment.

The position-dependent intra prediction sample filter 603 may repeatedly perform the PDPC operation shown in FIG. 7 for a respective sample of samples in the current block. The respective sample will be referred to as a current sample in this disclosure.

Referring to FIG. 7, at 701, the position-dependent intra prediction sample filter 603 receives an intra prediction mode and intra prediction samples for the current block.

At 703, the position-dependent intra prediction sample filter 603 checks the intra prediction mode used for generating the intra prediction samples for the current block.

If the position-dependent intra prediction sample filter 603 determines that the intra prediction mode is the Planar mode at 705, the position-dependent intra prediction sample filter 603 performs the operation 709 to determine positional dependent weights w_{L} and w_{T}.

If the position-dependent intra prediction sample filter 603 determines that the intra prediction mode is the DC mode at 707, the position-dependent intra prediction sample filter 603 performs the operation 709 to determine positional dependent weights w_{L} and w_{T}.

If the intra prediction mode is the Planar mode or the DC mode, the position-dependent intra prediction sample filter 603 determines positional dependent weights w_{L} and w_{T} for a current sample P(x, y) at 709, as shown in Equation 6.

$${w}_{L} = 32 ≫ ( ( x ≪ 1 ) ≫ scale ) \qquad Equation 6$$

$${w}_{T} = 32 ≫ ( ( y ≪ 1 ) ≫ scale )$$

The variable scale may be determined as shown in Equation 7.

$$scale = ( {log}_{2} w + {log}_{2} h - 2 ) ≫ 2 \qquad Equation 7$$

In Equation 7, the variables w and h are the width and height of the current block.

At 711, if the intra prediction mode is the Planar mode or the DC mode, the position-dependent intra prediction sample filter 603 determines neighboring reference samples R_{L} and R_{T} for the current sample P(x, y) as shown in Equation 8.

$${R}_{L} = R ( - 1 , y ) \qquad Equation 8$$

$${R}_{T} = R ( x , - 1 )$$

In Equation 8, R(−1, y) represents a left neighboring reference sample whose vertical position is equal to the vertical position of the current sample P(x, y). R(x, −1) represents a top neighboring reference sample whose vertical position is equal to the vertical position of the current sample P(x, y).

If the position-dependent intra prediction sample filter 603 determines that the intra prediction mode is the vertical mode or the horizontal mode at 713, the position-dependent intra prediction sample filter 603 determines whether the prediction mode is the vertical mode at 715.

If the prediction mode is the vertical mode, the position-dependent intra prediction sample filter 603 determines positional dependent weights w_{L} and w_{T} for a current sample P(x, y) at 717, as shown in Equation 9.

$${w}_{L} = 32 ≫ ( ( x ≪ 1 ) ≫ scale ) \qquad Equation 9$$

$${w}_{T} = 0$$

In Equation 9, the variable scale may be determined as shown in Equation 7.

If the prediction mode is not the vertical mode, i.e., if the prediction mode is the horizontal mode, the position-dependent intra prediction sample filter 603 determines positional dependent weights w_{L} and w_{T} for a current sample P(x, y) at 719, as shown in Equation 10.

$${w}_{L} = 0 \qquad Equation 10$$

$${W}_{T} = 32 ≫ ( ( x ≪ 1 ) ≫ scale )$$

In Equation 10, the variable scale may be determined as shown in Equation 7.

If the intra prediction mode is the vertical mode or the horizontal mode, the position-dependent intra prediction sample filter 603 determines neighboring reference samples R_{L} and R_{T} for the current sample P(x, y) at 721, as shown in Equation 11.

$${R}_{L} = R ( - 1 , y ) - R ( - 1 , - 1 ) + P ( x , y ) \qquad Equation 11$$

$${R}_{T} = R ( x , - 1 ) - R ( - 1 , - 1 ) + P ( x , y )$$

In Equation 11, R(−1, −1) represents a top left neighboring reference sample of the current block.

If the position-dependent intra prediction sample filter 603 determines that the intra prediction mode is one of angular modes at 723, the position-dependent intra prediction sample filter 603 determines whether the intra prediction mode is greater than a first predetermined mode, at 725. In some embodiments, the first predetermined mode may be, but not limited to, 50.

If the intra prediction mode is not greater than 50, the position-dependent intra prediction sample filter 603 determines whether the intra prediction mode is less than a second predetermined mode, at 727. In some embodiments, the second predetermined mode may be, but not limited to, 18.

If the intra prediction mode is less than 18, the position-dependent intra prediction sample filter 603 determines whether the variable y is less than (3<<scale), at 729.

If the variable y is less than (3<<scale), the position-dependent intra prediction sample filter 603 determines neighboring reference samples R_{L} and R_{T} for the current sample P(x, y) at 731, as shown in Equation 12.

$${R}_{L} = 0 \qquad Equation 12$$

$${R}_{T} = R ( xIntercept , - 1 )$$

If the variable y is not less than (3<<scale), the position-dependent intra prediction sample filter 603 determines neighboring reference samples R_{L} and R_{T} for the current sample P(x, y) at 733, as shown in Equation 13.

$${R}_{L} = 0 \qquad Equation 13$$

$${R}_{T} = 0$$

If the intra prediction mode is less than 18, the position-dependent intra prediction sample filter 603 determines positional dependent weights w_{L} and w_{T} for a current sample P(x, y) at 735, as shown in Equation 14.

$${w}_{L} = 0 , \qquad Equation 14$$

$${w}_{T} = 32 ≫ ( ( y ≪ 1 ) ≫ scale ) ,$$

where scale=min(2, log₂ w−floor(log₂(3×invAng−2))+8)

In Equation 14, the variable w represents a width of the current transform block and the variable invAng represents an inverse angle parameter which can be determined based on the intra prediction mode.

If the intra prediction mode is greater than 50, the position-dependent intra prediction sample filter 603 determines whether the variable x is less than (3<<scale) at 737.

If the variable x is less than (3<<scale), at 739, the position-dependent intra prediction sample filter 603 determines neighboring reference samples R_{L} and R_{T} for the current sample P(x, y) as shown in Equation 15.

$${R}_{L} = R ( - 1 , yIntercept ) \qquad Equation 15$$

$${R}_{T} = 0$$

If the variable x is not less than (3<<scale), the position-dependent intra prediction sample filter 603 determines neighboring reference samples R_{L} and R_{T} for the current sample P(x, y) as shown in Equation 16 at 741.

$${R}_{L} = 0 \qquad Equation 16$$

$${R}_{T} = 0$$

If the intra prediction mode is greater than 50, the position-dependent intra prediction sample filter 603 determines positional dependent weights w_{L} and w_{T} for a current sample P(x, y) at 743, as shown in Equation 17.

$${w}_{L} = 32 ≫ ( ( x ≪ 1 ) ≫ scale ) , \qquad Equation 17$$

$${w}_{T} = 0 ,$$

where scale=min(2,log₂ h−floor(log₂(3×invAng−2))+8)

In Equation 17, the variable h represents a height of the current transform block

At 745, the position-dependent intra prediction sample filter 603 generates a modified intra prediction sample P(x, y) as shown in Equation 18.

$$P ( x , y ) = ( {w}_{L} {R}_{L} + {w}_{T} {R}_{T} + ( 64 - {w}_{L} - {w}_{T} ) P ( x , y ) + 32 ) >> 6 \qquad Equation 18$$

At 747, the position-dependent intra prediction sample filter 603 outputs the modified intra prediction sample P(x, y).

As described with reference to FIG. 6 and FIG. 7, PDPC is a post filtering process performed after intra prediction process when the intra prediction mode is the Planar mode, DC mode, Vertical mode, Horizontal mode, or some angular modes. The definition of position weights and the corresponding reference samples are slightly different depending on the intra prediction mode. When non-zero position weights are used, however, the same PDPC weights are used as shown in Table 1. The weights for different scale s can be subsampled from a weight vector wₜ. And the weight coefficients in wₜ are fixed. In the present disclosure, the design of position weights for PDPC may be optimized.

In some embodiments, the position weights may be designed for different intra prediction modes m to better capture the block features of each prediction mode. The PDPC weights for each prediction mode m may be modeled as a one-dimensional (1D) vector with 16 elements, i.e. W=[w₀, w₁, . . . , w₁₅]. The vectors of the PDPC weights for Planar, DC, Horizontal/Vertical and certain Angular mode are referred to as W_{Planar}, W_{DC}, W_{HV} and W_{Angular}. Once W_{Planar}, W_{DC}, W_{HV} and W_{Angular} are given, the position weights w(z) for any pixel position (x, y) (where x, y are the row or column index of a pixel) may be determined using the down sampling scheme shown in Table 1 based on the scaling factor s and also based on the intra prediction mode m, as shown in Equation 19.

$$w ( z ) = {W}_{m} [ z << ( 2 - s ) ] \qquad Equation 19$$

In Equation 19, z=x when w_{L} is queried, and z=y when w_{T} is queried.

In some embodiments, PDPC weights vector for each scaling factor s of each mode may be designed independently, where the scaling factor s=(log₂ w+log₂ h−2)>>2. The possible value for the scaling factor s is 0,1,2, which is determined by the area of a block as shown in Table 2. The Table 2 shows scaling factor s depending on block sizes.

TABLE 2

| | w × h < 64 | 64 ≤ w × h < 1024 | w × h ≥ 1024 |
|---|---|---|---|
| s | 0 | 1 | 2 |

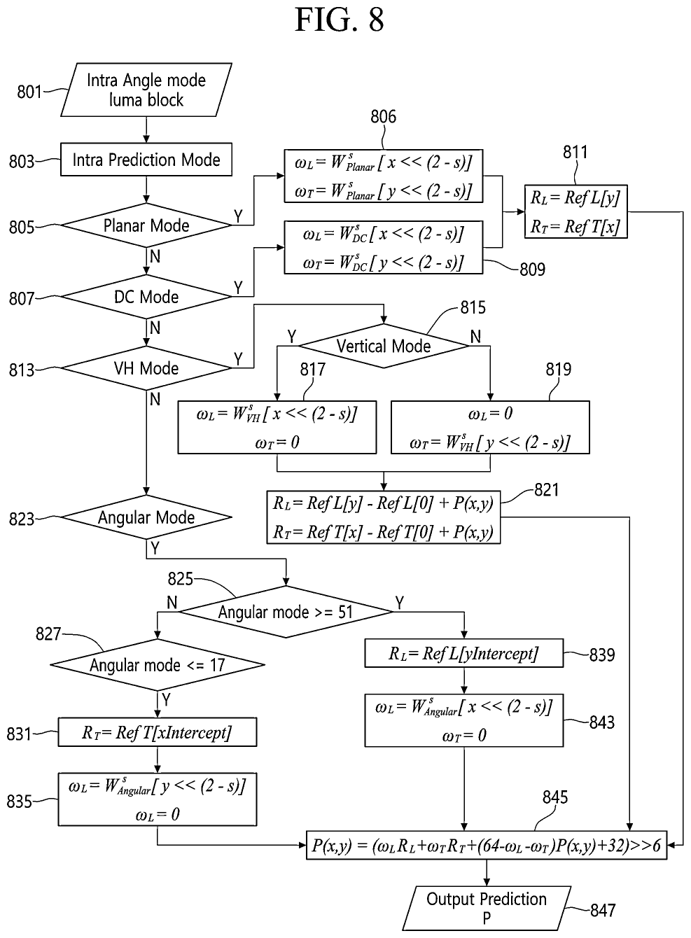

As shown in Table 2, the larger blocks have larger scaling factor. When the number of pixels of a block is less than 64, (e.g., blocks with size 4×4, 4×8, etc.), the scaling factor is 0. When the number of pixels is larger than or equal to 1024 (e.g., blocks with size 16×64, 32×32, etc.), the scaling factor is 2. Otherwise, the scaling factor is 1. In some embodiments, to design different PDPC weights for each scaling factor, position weights may capture the features of certain block sizes. The position weights are referred to as Wₘ^{s}, s∈{0,1,2}, m∈{Planar, DC, HV, Angular}. Once the pixel coordinate (x, y), the scaling factor s and the prediction mode m are given, the weight can be queried as w(z)=Wₘ^{s}[z<<(2−s)], where z=x for w_{L} and z=y for w_{T}. In some embodiments, the PDPC weight array Wₘ^{s} may be modeled as a one-dimensional vector with 4, 8, 16 parameters respectively for s=0, 1, 2. In some embodiments, the PDPC weight array Wₘ^{s} may be up sampled to 16 elements for s=0.1 by padding 0s for the simplicity. For example, a PDPC weight array [w₀, w₁, w₂, w₃] may be up sampled to be [w₀, 0,0,0, w₁, 0,0,0, w₂, 0,0,0, w₃, 0,0,0]. The detailed description for the PDPC calculation with the new weighting scheme will be described with reference to FIG. 8. Besides the different position weights design, the PDPC calculation may be extended to the entire block in certain Angular mode, while only the upper-left corner of a block is adjusted based on PDPC in VVC.

FIG. 8 is a flow chart showing a PDPC scheme in accordance with an embodiment.

Referring to FIG. 8, at 801, the position-dependent intra prediction sample filter 603 receives an intra prediction mode and intra prediction samples for the current block.

At 803, the position-dependent intra prediction sample filter 603 checks the intra prediction mode used for generating the intra prediction samples for the current block.

If the position-dependent intra prediction sample filter 603 determines that the intra prediction mode is the Planar mode at 805, the position-dependent intra prediction sample filter 603 performs the operation 806 to determine positional dependent weights w_{L} and w_{T}.

If the intra prediction mode is the Planar mode, the position-dependent intra prediction sample filter 603 determines positional dependent weights w_{L} and w_{T} for a current sample P(x, y) at 806, as shown in Equation 20.

$${w}_{L} ( x ) = {W}_{Planar}^{s} [ x << ( 2 - s ) ] \\ {w}_{T} ( y ) = {W}_{Planar}^{s} [ y << ( 2 - s ) ] \qquad Equation 20$$

In Equation 20, the variable s represents the variable scale, and it may be determined as shown in Equation 7.

If the position-dependent intra prediction sample filter 603 determines that the intra prediction mode is the DC mode at 807, the position-dependent intra prediction sample filter 603 performs the operation 809 to determine positional dependent weights w_{L} and w_{T}.

If the intra prediction mode is the DC mode, the position-dependent intra prediction sample filter 603 determines positional dependent weights w_{L} and w_{T} for a current sample P(x, y) at 809, as shown in Equation 21.

$${w}_{L} ( x ) = {W}_{DC}^{S} [ x << ( 2 - s ) ] \\ {w}_{T} ( y ) = {W}_{DC}^{S} ⌈ y << ( 2 - s ) ] \qquad Equation 21$$

In Equation 21, the variable s represents the variable scale, and it may be determined as shown in Equation 7.

At 811, if the intra prediction mode is the Planar mode or the DC mode, the position-dependent intra prediction sample filter 603 determines neighboring reference samples R_{L} and R_{T} for the current sample P(x, y) as shown in Equation 8.

If the position-dependent intra prediction sample filter 603 determines that the intra prediction mode is the vertical mode or the horizontal mode at 813, the position-dependent intra prediction sample filter 603 determines whether the prediction mode is the vertical mode at 815.

If the prediction mode is the vertical mode, the position-dependent intra prediction sample filter 603 determines positional dependent weights w_{L} and w_{T} for a current sample P(x, y) at 817, as shown in Equation 22.

$${w}_{L} ( x ) = {W}_{VH}^{S} [ x << ( 2 - s ) ] \\ {w}_{T} ( y ) = 0 \qquad Equation 22$$

In Equation 22, the variable s represents the variable scale, and it may be determined as shown in Equation 7.

If the prediction mode is not the vertical mode, i.e., if the prediction mode is the horizontal mode, the position-dependent intra prediction sample filter 603 determines positional dependent weights w_{L} and w_{T} for a current sample P(x, y) at 819, as shown in Equation 23.

$${w}_{L} ( x ) = 0 {w}_{T} ( y ) = {W}_{V H}^{S} [ y << ( 2 - s ) ] \qquad Equation 23$$

In Equation 23, the variable s represents the variable scale, and it may be determined as shown in Equation 7.

If the intra prediction mode is the vertical mode or the horizontal mode, the position-dependent intra prediction sample filter 603 determines neighboring reference samples R_{L} and R_{T} for the current sample P(x, y) at 821, as shown in Equation 11.

If the position-dependent intra prediction sample filter 603 determines that the intra prediction mode is one of angular modes at 823, the position-dependent intra prediction sample filter 603 determines whether the intra prediction mode is greater than a first predetermined mode at 825. In some embodiments, the first predetermined mode may be 50.

If the intra prediction mode is not greater than 50, the position-dependent intra prediction sample filter 603 determines whether the intra prediction mode is less than a second predetermined mode at 827. In some embodiments, the second predetermined mode may be 18.

If the intra prediction mode is less than 18, the position-dependent intra prediction sample filter 603 determines neighboring reference samples R_{L} and R_{T} for the current sample P(x, y) at 831, as shown in Equation 12.

If the intra prediction mode is less than 18, the position-dependent intra prediction sample filter 603 determines positional dependent weights w_{L} and w_{T} for a current sample P(x, y) at 835, as shown in Equation 24.

$${w}_{L} ( x ) = 0 , and {w}_{T} ( y ) = {W}_{Angular}^{s} ⌈ y << ( 2 - s ) ] , \qquad Equation 24$$

where s=min(2, log₂ w−floor(log₂(3×invAng−2))+8)

In Equation 24, the variable w represents a weight of the current transform block.

If the intra prediction mode is greater than 50, the position-dependent intra prediction sample filter 603 determines neighboring reference samples R_{L} and R_{T} for the current sample P(x, y) at 839, as shown in Equation 15.

If the intra prediction mode is greater than 50, the position-dependent intra prediction sample filter 603 determines positional dependent weights w_{L} and w_{T} for a current sample P(x, y) at 843, as shown in Equation 25.

$${w}_{L} ( x ) = {W}_{Angular}^{s} [ x << ( 2 - s ) ] , and \\ {w}_{T} ( y ) = 0 , \qquad Equation 25$$

where s=min(2, log₂ h−floor(log₂(3×invAng−2))+8)

In Equation 25, the variable h represents a height of the current transform block

At 845, the position-dependent intra prediction sample filter 603 generates a modified intra prediction sample P(x, y) as shown in Equation 18.

At 847, the position-dependent intra prediction sample filter 603 outputs the modified intra prediction sample P(x, y).

In some embodiments, different position weights for PDPC may be designed for different scaling factors, i.e. the area of a block. In some embodiments, the position weights may be also designed for each block size so that the PDPC weights can better capture the features for each block size. Suppose the block size is w×h, then position weights arrays are referred to as Wₘ^{w,h}, m∈{Planar, DC, HV, Angular}, which are modeled as 1D vectors with w+h elements. In some embodiments, the first w elements of the array Wₘ^{w,h} may represent the weights along the width and the last h elements of the array Wₘ^{w,h} may represent the weights along the height. The positional dependent weights w_{L}(x) and w_{T}(y) for a current sample P(x, y) are determined as shown in Equation 26.

$${w}_{L} ( x ) = {W}_{m}^{w , h} ( x ) , and {w}_{T} ( y ) = {W}_{m}^{w , h} ( w + y ) \qquad Equation 26$$

In Equation 26, the variable m represents the intra prediction mode and the variables w and h represent the width and height of the current transform block, respectively.

In some embodiments, to reduce the complexity, the dimension of the weight vector Wₘ^{w,h} may be reduced by factor p_{w,h} and q_{w,h}. For example, the positional dependent weights w_{L}(x) and w_{T}(y) for a current sample P(x, y) are determined as shown in Equation 27.

$${w}_{L} ( x ) = {W}_{m}^{w , h} ( ⌊ x / {p}_{w , h} ⌋ ) , and {w}_{T} ( y ) = {W}_{MODE}^{w , h} ( ⌊ w / {p}_{w , h} ⌋ + ⌊ y / {q}_{w , h} ⌋ ) , \qquad Equation 27$$

where └z┘ represents the floor of z and returns the largest integer less than or equal to z.

In some embodiments, the other reduction scheme like the scaling factor scheme may be used to separate the width and/or height to certain segments. Each segment may share one weight coefficient.

In some embodiments, PDPC weights can be designed along one dimension (either width or height) of a block instead of the area of a block. For example, PDPC weights array Wₘ^{l}, may be used, where l={1,2,4,8,16,32,64}, m∈{Planar, DC, HV, Angular}, and w/h=1,2,4,8,16,32,64. In this scenario, the PDPC weight w_{L} may be queried based on the width w of the current block and the horizontal position x of the current sample and w_{T} may be queried based on the height h of the current block and the vertical position y of the current sample. When scaling factor pₗ is used in the weight modeling to reduce the number of parameters for each size l, the positional dependent weights w_{L}(x) and w_{T}(y) for a current sample P(x, y) may be determined as shown in Equation 28.

$${w}_{L} ( x ) = {W}_{m}^{w} [ ⌊ x / {p}_{w} ⌋ ] {w}_{T} ( y ) = {W}_{m}^{h} [ ⌊ y / {p}_{h} ⌋ ] \qquad Equation 28$$

If the scaling factors p_{w} and pₕ are 1, w_{L}=Wₘ^{x}[x], w_{T}=Wₘ^{h}[y].

Hereinafter, the method for designing the position weight coefficients to improve the coding efficiency will be described.

In some embodiments, a data-driven method to infer the PDPC weights may be used. For example, a PDPC weights array WAS based on both the intra prediction mode m∈{Planar, DC, HV, Angular} and the scaling factor s∈{0,1,2} may be determined. The same method may be applied to infer the weights for other schemes. Each PDPC weight array Wₘ^{s} may be modeled as a 1D vector with 4, 8, 16 parameters respectively for s=0, 1, 2. Therefore, there may be (4+8+16)*4=112 parameters in total. In some embodiments, PDPC weight arrays Wₘ¹ and Wₘ² may be up sampled to 16 elements by padding 0s for the simplicity. For example, the array [w₀, w₁, w₂, w₃] may be up-sampled to be Wₘ¹=[w₀, 0,0,0, w₁, 0,0,0, w₂, 0,0,0, w₃, 0,0,0]. The position weights w_{L} and w_{T} for a pixel (x, y) may be quired as shown in Equation 29.

$${W}_{L} ( x ) = {W}_{m}^{s} [ x << ( 2 - s ) ] , \\ {W}_{T} ( y ) = {W}_{m}^{s} [ y << ( 2 - s ) ] . \qquad Equation 29$$

In Equation 29, the variable m represents the intra prediction and the variable s represents a scale value.

The reference samples R_{L} and R_{T} may be determined as shown in Equation 30.

$${R}_{L} = {f}_{L} ( RefL , x , y , m , p ) ] , {R}_{T} = {f}_{T} ( RefT , x , y , m , p ) . \qquad Equation 30$$

As shown in Equation 30, the reference samples R_{L} may be determined based on left boundary reference samples, the position of the current sample, the intra prediction mode m, a predicted sample P for the current sample, and prediction parameter p like prediction angular. The reference samples R_{T} may be determined based on top boundary reference samples, the position of the current sample, the intra prediction mode m, a predicted sample P for the current sample, and prediction parameter p like prediction angular. After applying PDPC, the predicted sample may be modified to generate a modified predicted sample P(x, y) as shown in Equation 18. The difference between an original sample Y(x, y) and its prediction sample P(x, y) may be referred to as a prediction residual or simply a residual. Better coding gain may mean smaller residual. We transform the residual by T, where T is the two-dimensional DCT-II. The loss function based on coefficients c may be used to approximate the coding cost. The exemplary loss function l(c) is shown in, but not limited to, Equation 31.

$$l ( c ) = \vert c \vert + α g ( β \vert c \vert - r ) , \qquad Equation 31$$

In Equation 31, the function g(x) represents the logistic function as shown in Equation 32.

$$g ( x ) = 1 / ( 1 + {e}^{- x} ) \qquad Equation 32$$

While other loss functions to model the prediction residual can be used as well, it has been found that the loss function shown in Equation 32 leads to better convergence than using the mean square error (MSE) of the residual. The sum over the losses may be minimized for all the blocks with the same scaling factor s and same mode m to search for the best weights array Wₘ^{s}.

The training dataset may be generated from CTC videos. The optimization may be implemented in Pytorch with ADAM optimizer with learning rate started at 0.0005 and with a reduce factor 1.3⁻¹. The batch size is 64. An example of the optimized PDPC weights arrays is shown in Table 3 and its corresponding coding gains are shown in Table 4.

Table 3 shows an example of optimized PDPC weights for different modes and scales.

TABLE 3

| | | |
|---|---|---|
| W_{Planar}^{s} | s = 0 | [31, 10, 2, 1] |
| | s = 1 | [33, 18, 8, 4, 1, 0, 0, 0] |
| | s = 2 | [27, 22, 17, 14, 11, 8, 6, 5, 3, 2, 2, 1, 1, 0, 0, 0] |
| W_{DC}^{s} | s = 0 | [23, 8, 2, 1] |
| | s = 1 | [26, 14, 7, 4, 1, 1, 1, 0] |
| | s = 2 | [20, 15, 11, 8, 6, 4, 3, 2, 2, 1, 1, 1, 0, 0, 0, 0] |
| W_{VH}^{s} | s = 0 | [34, 10, 2, 0] |
| | s = 1 | [35, 18, 9, 5, 3, 2, 0, 0] |
| | s = 2 | [32, 26, 21, 17, 13, 11, 9, 8, 6, 5, 4, 2, 0, 0, 0, 0] |
| W_{Angular}^{s} | s = 0 | [31, 11, 4, 0] |
| | s = 1 | [33, 19, 12, 7, 4, 2, 0, 0] |
| | s = 2 | [34, 28, 22, 18, 14, 11, 9, 7, 6, 5, 3, 2, 0, 0, 0, 0] |

As shown in Table 3, W_{Planar}⁰≠W_{DC}⁰, W_{Planar}⁰≠W_{VH}⁰, W_{Planar}⁰≠W_{Angular}⁰, W_{DC}⁰≠W_{VH}⁰, W_{DC}⁰≠W_{Angular}⁰, W_{VH}⁰≠W_{Angular}⁰, W_{Planar}¹≠W_{DC}¹, W_{Planar}¹≠W_{VH}¹, W_{Planar}¹≠W_{Angular}¹, W_{DC}¹≠W_{VH}¹, W_{DC}¹≠W_{Angular}¹, W_{VH}¹≠W_{Angular}¹, W_{Planar}²≠W_{DC}², W_{Planar}²≠W_{VH}², W_{Planar}²≠W_{Angular}², W_{DC}²≠W_{VH}², W_{DC}²≠W_{Angular}², and W_{VH}²≠W_{Angular}².

Furthermore, for each intra prediction mode, a set of elements in a weight array for a smaller scale is not a subset of a set of elements of a weight array for a bigger scale. For example, elements in W_{Planar}⁰ is not a subset of elements in W_{Planar}¹, elements in W_{Planar}⁰ is not a subset of elements in W_{Planar}², and elements in w_{Planar}¹ is not a subset of elements in W_{Planar}².

Table 4 shows coding performance of the exemplary optimized PDPC weights over VVC test model 19.2 (VTM-19.2) for all intra Main10 profiles.

TABLE 4

| Class | Y | U | V |
|---|---|---|---|
| Class A1 | −0.13% | −0.34% | −0.22% |
| Class A2 | −0.13% | 0.01% | −0.04% |
| Class B | −0.10% | −0.01% | 0.16% |
| Class C | −0.01% | −0.09% | −0.16% |
| Class E | −0.07% | 0.12% | −0.44% |
| Overall | −0.08% | −0.06% | −0.11% |
| Class D | 0.01% | 0.51% | −0.21% |
| Class F | −0.03% | 0.42% | −0.13% |

In some embodiments, the PDPC weights for different video resolutions may be optimized. The coding performance can be further improved as shown in Table 5. Table 5 shows coding performance of the optimized PDPC weights for different video resolution over VVC test model 19.2 (VTM-19.2) for all intra Main10 profiles.

TABLE 5

| Class | Y | U | V |
|---|---|---|---|
| Class A1 | −0.20% | −0.16% | −0.02% |
| Class A2 | −0.09% | 0.08% | −0.02% |
| Class B | −0.10% | −0.01% | 0.16% |
| Class C | −0.06% | 0.19% | −0.13% |
| Class E | −0.12% | 0.30% | −1.01% |
| Overall | −0.11% | 0.08% | −0.16% |
| Class D | −0.14% | 0.48% | −0.01% |
| Class F | −0.08% | 0.40% | −0.52% |

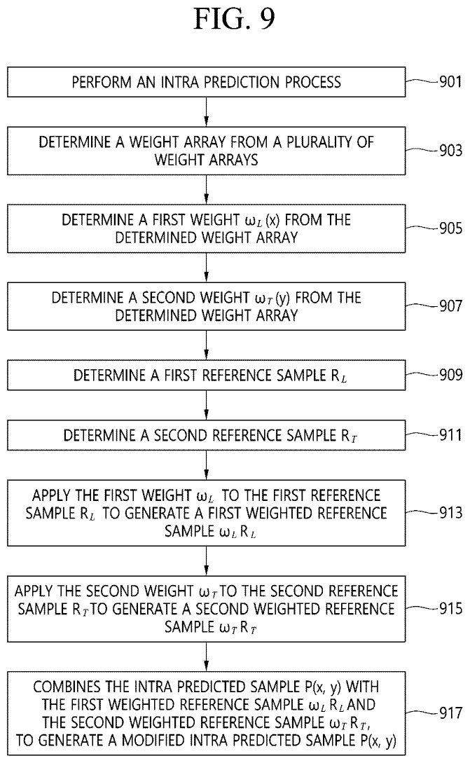

Hereinafter, the operation of the intra-frame predictor 600 will be described with reference to FIG. 9.

FIG. 9 is a flow chart showing the operation of the intra-frame predictor in accordance with an embodiment.

The intra-frame predictor 600 performs an intra prediction process based on an intra prediction mode for a current block to generate an intra predicted sample for a current sample in the current block, at 901.

The intra-frame predictor 600 determines a weight array from a plurality of weight arrays, at 903.

In some embodiments, the plurality of weight arrays may be associated with a respective one of a plurality of intra prediction modes. For example, the plurality of weight arrays may include W_{Planar}, W_{DC}, W_{VH}, and W_{Angular}. The weight array W_{Planar} may be associated with the Planar mode. W_{DC} may be associated with the DC mode. W_{VH} may be associated with the vertical mode and the horizontal mode. W_{Angular} may be associated with some angular modes greater than 50 or less than 18. In some embodiments, a first one of the plurality of weight arrays may be different from a second one of the plurality of weight arrays. In some embodiments, the plurality of weight arrays may be different from each other, for the same block size or the same scale. For example, for the same block size or the same scale, some or all of the following may be satisfied: W_{Planar}≠W_{DC}, W_{Planar}≠W_{VH}, W_{Planar}≠W_{Angular}, W_{DC}≠W_{VH}, W_{DC}≠W_{Angular}, W_{VH}≠W_{Angular}.

In some embodiments, the plurality of weight arrays may be associated with a respective one of a plurality of intra prediction modes and with a respective one of a plurality of scale values. For example, the plurality of weight arrays may include W_{Planar}, W_{DC}⁰, W_{VH}⁰, W_{Angular}⁰, W_{Planar}¹, W_{DC}¹, W_{VH}¹, W_{Angular}¹, W_{Planar}², W_{DC}², W_{VH}², and W_{Angular}². The weight array Wₘ^{s} may be associated with the intra prediction mode m (m=Planar, DC, Vertical and Horizontal, Angular modes greater than 50 or less than 18) and the scale s (s=0,1,2). In some embodiments, a first one of the plurality of weight arrays may be different from a second one of the plurality of weight arrays, for the same block size or the same scale. For example, some or all of the following may be satisfied: W_{Planar}⁰≠W_{DC}⁰, W_{Planar}⁰≠W_{VH}⁰, W_{Planar}⁰≠W_{Angular}⁰, W_{DC}⁰≠W_{VH}⁰, W_{DC}⁰≠W_{Angular}⁰, W_{VH}⁰≠W_{Angular}⁰, W_{Planar}¹≠W_{DC}¹, W_{Planar}¹≠W_{VH}¹, W_{Planar}¹≠W_{Angular}¹, W_{DC}¹≠W_{VH}¹, W_{DC}¹≠W_{Angular}¹, W_{VH}¹≠W_{Angular}¹, W_{Planar}²≠W_{DC}², W_{Planar}²≠W_{VH}², W_{Planar}²≠W_{Angular}², W_{DC}²≠W_{VH}², W_{DC}²≠W_{Angular}², W_{VH}²≠W_{Angular}². In some embodiments, for a respective one of some or all intra prediction modes, a set of elements in a weight array for a smaller scale may not be a subset of a set of elements of a weight array for a bigger scale.

In some embodiments, the plurality of weight arrays may be different from each other, for the same block size or the same scale, for the same block size or the same scale.

In some embodiments, the plurality of weight arrays may be associated with a respective one of a plurality of intra prediction modes and with a respective one of a plurality of scale values. For example, the plurality of weight arrays may include W_{Planar}^{w,h}, W_{DC}^{w,h}, W_{VH}^{w,h} and W_{Angular}^{w,h}. The weight array Wₘ^{w,h} may be associated with the intra prediction mode m (m=Planar, DC, Vertical and Horizontal, Angular modes greater than 50 or less than 18) and the width w, and the height h of the current block (w/h=1,2,4,8,16,32,64). In some embodiments, a first one of the plurality of weight arrays may be different from a second one of the plurality of weight arrays. In some embodiments, the plurality of weight arrays may be different from each other, for the same block size or the same scale. In some embodiments, for a respective one of some or all intra prediction modes, a set of elements in a weight array for a smaller block size may not be a subset of a set of elements of a weight array for a bigger block size.

In some embodiments, the plurality of weight arrays may be associated with a respective one of a plurality of intra prediction modes and with a respective one of a plurality of scale values. For example, the plurality of weight arrays may include W_{Planar}^{w}, W_{DC}^{w}, W_{VH}^{w}, W_{Angular}^{w}, W_{Planar}^{h}, W_{DC}^{h}, W_{VH}^{h}, and W_{Angular}^{h}. The weight array Wₘ^{w} may be associated with the intra prediction mode m (m=Planar, DC, Vertical and Horizontal, Angular modes greater than 50 or less than 18) and the width w of the current block (w=1,2,4,8,16,32,64). The weight array Wₘ^{w} may be associated with the intra prediction mode m (m=Planar, DC, Vertical and Horizontal, Angular modes greater than 50 or less than 18) and the height h of the current block (h=1,2,4,8,16,32,64). In some embodiments, a first one of the plurality of weight arrays may be different from a second one of the plurality of weight arrays. In some embodiments, the plurality of weight arrays may be different from each other, for the same block size or the same scale. In some embodiments, for a respective one of some or all intra prediction modes, a set of elements in a weight array for a smaller width or height may not be a subset of a set of elements of a weight array for a bigger width or height.

The intra-frame predictor 600 determines a first weight w_{L}(x) from the determined weight array based on the position of the current sample, at 905.

The intra-frame predictor 600 determines a second weight w_{T}(y) from the determined weight array based on the position of the current sample, at 907.

The intra-frame predictor 600 determines a first reference sample R_{L} based on the position of the current sample, at 909.

The intra-frame predictor 600 determines a second reference sample R_{T} based on the position of the current sample, at 911.

The intra-frame predictor 600 applies the first weight w_{L} to the first reference sample R_{L} to generate a first weighted reference sample w_{L}R_{L}, at 913.

The intra-frame predictor 600 applies the second weight w_{T} to the second reference sample R_{T} to generate a second weighted reference sample w_{T}R_{T}, at 915.

The intra-frame predictor 600 combines the intra predicted sample P(x, y) for the current sample with the first weighted reference sample w_{L}R_{L} and the second weighted reference sample w_{T}R_{T}, to generate a modified intra predicted sample P(x, y) for the current sample, at 917.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
a communication interface configured to receive a compressed bitstream; and
a processor operably coupled to the communication interface, the processor configured to:
perform an intra prediction process based on an intra prediction mode for a current block to generate an intra predicted sample for a current sample in the current block,
determine a weight array based on the intra prediction mode for the current block, from a plurality of weight arrays, each of the plurality of weight arrays being associated with a respective one of a plurality of intra prediction modes,
determine a weight from the determined weight array based on a position of the current sample,
generate a modified intra predicted sample for the current sample based on the determined weight and the intra predicted sample for the current sample.

2. The apparatus of claim 1, wherein the plurality of weight arrays include a first weight array and a second weight array,
the first weight array is associated with a first intra prediction mode,
the second weight array is associated with a second intra prediction mode, and
the first weight array is different from the second weight array.

3. The apparatus of claim 1, wherein the first intra prediction mode is one of a Planar mode, a DC mode, a horizontal mode, a vertical mode, or an angular mode, and the second intra prediction mode is another one of the Planar mode, the DC mode, the horizontal mode, the vertical mode, or the angular mode.

4. The apparatus of claim 1, wherein the weight array is determined further based on a scale,
the scale is determined based on a size of the current block, and
each of the plurality of weight arrays is associated with a respective one of the plurality of intra prediction modes and associated with a respective one of a plurality of scales.

5. The apparatus of claim 4, wherein the plurality of weight arrays include a first weight array and a second weight array,
the first weight array is associated with a first intra prediction mode and a first scale,
the second weight array is associated with a second intra prediction mode and the first scale, and
the first weight array is different from the second weight array.

6. The apparatus of claim 4, wherein the plurality of weight arrays include a first weight array and a second weight array,
the first weight array is associated with a first intra prediction mode and a first scale,
the second weight array is associated with a first intra prediction mode and a second scale, and
the first weight array is different from the second weight array.

7. The apparatus of claim 6, wherein the second scale is bigger than the first scale, and a set of elements in the first weight array is not a subset of a set of elements in the second weight array.

8. The apparatus of claim 1, wherein the weight array is determined further based on a width and a height of the current block,
each of the plurality of weight arrays is associated with a respective one of the plurality of intra prediction modes, associated with a respective one of a plurality of block widths, and associated with a respective one of a plurality of block heights.

9. The apparatus of claim 8, wherein the plurality of weight arrays include a first weight array and a second weight array,
the first weight array is associated with a first intra prediction mode, a first width, and a first height,
the second weight array is associated with a second intra prediction mode and the first scale, a first width, and a first height, and
the first weight array is different from the second weight array.

10. The apparatus of claim 9, wherein the weight is determined from the determined weight array based on the position of the current sample and a scaling factor, and the scaling factor is greater than 1.

11. The apparatus of claim 1, wherein generating the modified intra predicted sample for the current sample comprises:
determining a reference sample based on the position of the current sample,
applying the weight to the reference sample to generate a weighted reference sample, and
combining the intra predicted sample for the current sample with the weighted reference sample to generate a modified intra predicted sample for the current sample.

12. The apparatus of claim 1, wherein the processor is further configured to cause:
determining a residual for the current sample, and
combining the residual for the current sample with the residual for the current sample to reconstruct the current sample.

13. A video decoding method comprising:
receiving a compressed bitstream;
performing an intra prediction process based on an intra prediction mode for a current block to generate an intra predicted sample for a current sample in the current block;
determining a weight array based on the intra prediction mode for the current block, from a plurality of weight arrays, each of the plurality of weight arrays being associated with a respective one of a plurality of intra prediction modes;
determining a weight from the determined weight array based on a position of the current sample; and
generating a modified intra predicted sample for the current sample based on the determined weight and the intra predicted sample for the current sample.

14. The video decoding method of claim 13, wherein the plurality of weight arrays include a first weight array and a second weight array,
the first weight array is associated with a first intra prediction mode,
the second weight array is associated with a second intra prediction mode, and
the first weight array is different from the second weight array.

15. The video decoding method of claim 13, wherein the weight array is determined further based on a scale,
the scale is determined based on a size of the current block, and
each of the plurality of weight arrays is associated with a respective one of the plurality of intra prediction modes and associated with a respective one of a plurality of scales.

16. The video decoding method of claim 15, wherein the plurality of weight arrays include a first weight array and a second weight array,
the first weight array is associated with a first intra prediction mode and a first scale,
the second weight array is associated with a second intra prediction mode and the first scale, and
the first weight array is different from the second weight array.

17. The video decoding method of claim 13, wherein generating the modified intra predicted sample for the current sample comprises:
determining a reference sample based on the position of the current sample,
applying the weight to the reference sample to generate a weighted reference sample, and
combining the intra predicted sample for the current sample with the weighted reference sample to generate a modified intra predicted sample for the current sample.

18. An apparatus comprising:
a processor configured to cause:
performing an intra prediction process based on an intra prediction mode for a current block to generate an intra predicted sample for a current sample in the current block,
determining a weight array based on the intra prediction mode for the current block, from a plurality of weight arrays, each of the plurality of weight arrays being associated with a respective one of a plurality of intra prediction modes,
determining a weight from the determined weight array based on a position of the current sample,
generating a modified intra predicted sample for the current sample based on the determined weight and the intra predicted sample for the current sample,
generating a residual for the current sample based on the modified intra predicted sample; and
a communication interface operably coupled to the processor, the communication interface configured to transmit the compressed bitstream including a syntax element representing the residual.

19. The apparatus of claim 18, wherein the plurality of weight arrays include a first weight array and a second weight array,
the first weight array is associated with a first intra prediction mode,
the second weight array is associated with a second intra prediction mode, and
the first weight array is different from the second weight array.

20. The apparatus of claim 18, wherein the weight array is determined further based on a scale,
the scale is determined based on a size of the current block, and
each of the plurality of weight arrays is associated with a respective one of the plurality of intra prediction modes and associated with a respective one of a plurality of scales.
